(19) United States
(12) Patent Application Publication
(10) Pub. No.: US 2008/0118398 A1
(43) Pub. Date: May 22, 2008

(54) Assay Devices Comprising Sample-Activatable Batteries

(75) Inventors: Brian J. Birch, Bedford (GB); Balbir Raj, Bedford (GB)

Correspondence Address: FOLEY HOAG, LLP;PATENT GROUP (w/ISA), 155 SEAPORT BLVD., BOSTON, MA, 02210-2600, US

(73) Assignee: Inverness Medical Switzerland GmbH, Zug (CH)

(21) Appl. No.: 11/867,994

(22) Filed: Oct. 5, 2007

Related U.S. Application Data
(60) Provisional application No. 60/950,445, filed on Jul. 18, 2007.

(30) Foreign Application Priority Data
Oct. 5, 2006 (GB) 0619720.6

(51) Int. Cl. G01N 35/00

(52) U.S. Cl. 422/63

(57) ABSTRACT

Provided are assay devices comprising sample-activatable battery cells.

### RELATED APPLICATION INFORMATION

This application claims the benefit of U.S. Provisional Application No. 60/950,445, filed Jul. 18, 2007, and UK Application No., filed Oct. 5, 2006, the contents of which are hereby incorporated by this reference in their entirety.

### BACKGROUND

Electronic assay devices are now commercially available, such as the ClearBlue Digital™ device sold by Unipath Ltd for the detection of the pregnancy hormone human chorionic gonadotropin. Provision of an electronic assay device represents an advance over traditional visually read devices in that the results of a test may be displayed without user interpretation, the result may be semi or totally quantitative and the results may be stored into memory. However, such devices may include a number of photodiodes and photodetectors as well as electronics to process the signal and an LED display, all of which have certain power requirements. These devices are typically powered by commercially available button battery cells provided within the device. Environmental regulations in some countries require that the batteries are able to be removed from the device, which increases cost. Furthermore, there are environmental implications involved with indiscriminate disposal of such devices as well as further cost implications such as the cost of the battery itself. Therefore, alternative sources of power for electronic assay devices would be desirable, so that the use of a commercial battery with such devices is not required.

### SUMMARY

Provided are assay devices comprising sample-activatable batteries. Such devices do not require use of a separate, commercial battery and have a completely self-contained power system.

Further objectives and advantages of the present invention will become apparent as the description proceeds. To gain a full appreciation of the scope of the present invention, it will be further recognized that various aspects of the present invention can be combined to make desirable embodiments of the invention.

### BRIEF DESCRIPTION OF THE DRAWINGS

FIG. 1 is a schematic side view of an embodiment of an assay device comprising sample activatable batteries.

FIG. 2 shows, in plan view, an electrode configuration according to an embodiment of the invention.

FIG. 3 shows an embodiment of the porous sample receiver in the test strip, with compartmentalized layers.

FIG. 4 shows the current requirement of an LED component during the running of an assay device test.

FIG. 5 shows an embodiment showing a construction of battery cells.

### DETAILED DESCRIPTION

Unless defined otherwise above, all technical and scientific terms used herein have the same meaning as commonly understood by one of ordinary skill in the art to which this invention belongs. Where a term is provided in the singular, the inventor also contemplates the plural of that term. The nomenclature used herein and the procedures described below are those well known and commonly employed in the art.

The singular forms “a”, “an”, and “the” include plural references unless the context clearly dictates otherwise.

A “binding reagent” refers to a member of a binding pair, i.e., two different molecules wherein one of the molecules specifically binds with the second molecule through chemical or physical means. The two molecules are related in the sense that their binding with each other is such that they are capable of distinguishing their binding partner from other assay constituents having similar characteristics. The members of the specific binding pair (“sbp”) are referred to as ligand and receptor (antiligand), sbp member and sbp partner, and the like. In addition to antigen and antibody specific binding pair members, other specific binding pairs include biotin and avidin, carbohydrates and lectins, complementary nucleotide sequences, complementary peptide sequences, effector and receptor molecules, enzyme cofactors and enzymes, enzyme inhibitors and enzymes, a peptide sequence and an antibody specific for the sequence or the entire protein, polymeric acids and bases, dyes and protein binders, peptides and specific protein binders (e.g., ribonuclease, S-peptide and ribonuclease S-protein), and the like. Furthermore, specific binding pairs can include members that are analogues of the original specific binding member, for example an analyte-analogue or a specific binding member made by recombinant techniques or molecular engineering.

The terms “comprise” and “comprising” is used in the inclusive, open sense, meaning that additional elements may be included.

“Labeled binding reagent” refers to any substance comprising a detectable label attached to a binding reagent. The attachment may be covalent or non-covalent. The label provides a detectable signal that is related to the presence or amount of analyte in the fluid sample. Various labels suitable for use include labels which produce signals through either chemical, biochemical or physical means. Such labels can include enzymes and substrates, chromogens, catalysts, fluorescent compounds, chemiluminescent compounds, and radioactive labels. Other suitable labels include colloidal metallic particles such as gold or silver, colloidal non-metallic particles such as selenium or tellurium, dyed or colored particles such as a coloured polymer such as polystyrene, a stained microorganism or dyesols, organic polymer latex particles and liposomes, colored beads or electrochemically detectable species. Of the above, colored polymer particles and colloidal gold are preferred.

“Porous carrier” refers to a porous body capable of transporting fluid sample.

The term “sample” refers to any sample potentially containing an analyte. For example, a sample may be a bodily fluid such as blood, urine, mucous or saliva, or a respiratory sample, such as a nasopharyngeal wash or aspirate, nasal swab, nasopharyngeal swab, nasal wash, throat swab, transtracheal aspirate, bronchoalveolar lavage, elution buffer used to wash a respiratory sample, etc.

The term “sample activatable battery cell” refers to any cell capable of producing electrical current when contacted by a sample.

Provided are assay devices comprising at least one sample activatable battery cell.

According to a first aspect, the invention provides an assay device for determining the presence and/or amount of an analyte in a fluid sample, the device having a sample transporting means comprising a labeled binding reagent for the analyte, an analyte analogue or a binding reagent for the analyte, wherein said device comprises two or more sample activatable battery cells connected in series.

The assay device may comprise three or more sample activatable battery cells connected in series. The number of series connected sample activatable battery cells may be four, five, six, seven or more.

The liquid transporting means may be a porous carrier, such as a lateral flow porous carrier, or a microfluidic device comprising one or more capillary flow paths or a combination of a porous carrier and a microfluidic device. Lateral flow assay devices that may be modified to incorporate the sample activatable batteries are disclosed in EP291194 and EP383619.

The assay device may comprise one or more binding reagents for an analyte wherein the two more sample activated battery cells are provided upstream of the binding reagents on the sample transporting means.

The sample transporting means of the assay device may comprise one or more porous carriers, a first porous carrier, a second porous carrier and optionally, a porous sample receiver. The porous carriers may be strip-like in shape and abut or partially overlap each other in a linear arrangement. Alternatively they may be stacked on top of each other. They may be of any suitable dimensions.

In one embodiment, the assay device is of the lateral flow type comprising a first porous carrier in fluid connection with a second porous carrier, such that fluid sample applied to the device flows through the first porous carrier into the second porous carrier. Provided on and/or within the first porous carrier is a labeled binding reagent for the analyte of interest which is mobilizable by the fluid sample. Provided on and/or within the second porous carrier is an immobilized binding reagent for the analyte or labeled binding reagent. In use, fluid sample suspected of containing analyte is added to the assay device and is able to interact with and mobilize the dried labeled binding reagent provided on and/or within the first porous carrier. The mobilized binding reagent then travels to and is captured by the immobilized binding reagent provided at a detection zone, optionally provided on the first porous carrier or at the second porous carrier. The amount or presence of captured labeled binding reagent at the detection zone is indicative of the amount or presence of analyte in the fluid sample.

In certain embodiments, the first porous carrier may comprise a plastic material having an average pore size of not less than about 10 microns, and ideally about 100 microns, because such larger pore sizes give better release of the labeled reagent. The carrier should have minimal protein-binding, or should be blockable by means of reagents such as BSA or PVA, to minimize non-specific binding and to facilitate free movement of the labeled reagent after the first porous carrier has become moistened with the liquid sample. The carrier material may be pre-treated with surface active agent or solvent, if necessary, to render it more hydrophilic and to promote rapid uptake of the liquid sample. The first porous carrier may comprise glass fibre or a cellulosic material.

In certain embodiments, the porous carrier is any porous substrate that is capable of transporting fluid sample, i.e., is liquid conductive. Representative examples of liquid conductive materials include paper, nitrocellulose and nylon membranes. Important features of the material are its ability to bind protein; speed of liquid conduction; and, if necessary after pre-treatment with a blocking agent such as albumin or PVA, its ability to allow the passage of labeled binding reagents such as antibodies along the strip. If this is a particulate label, it may be desirable for the material to allow flow of particles of size up to a few microns (usually less than 0.5 μm). A preferred material is nitrocellulose.

As an alternative way of providing a sandwich type assay, instead of providing an immobilized binding reagent at a detection zone, the binding reagent may be conjugated to a large particle and provided in a mobilizable form, preferably at the first porous carrier and a filter zone may be provided at the detection zone which serves to capture any labeled binding reagent-analyte-binding reagent-large particle complex. The filter zone may be chosen of dimensions such that any labeled binding reagent not bound to a large particle would pass the filter zone.

As an alternative, in addition to providing a first mobilizable labeled binding reagent for the analyte, a second mobilizable binding reagent for the analyte and for an immobilized species provided at the detection zone may also be provided such that labeled binding reagent becomes bound at the detection zone in the presence of analyte.

The assay device may further comprise a porous sample receiver for facilitating the rapid uptake of a fluid sample. The porous sample receiver may be provided in fluid connection with and generally upstream of the first porous carrier.

The assay device may comprise a housing which may completely or partially house the liquid transporting means. The porous sample receiver may be provided such that it extends out of the housing through a suitable aperture. In this way, the device may be conveniently used for example to sample a urine stream.

A control zone may be provided on the first porous carrier or on the second porous carrier if present to indicate to the user that the device has worked. For example, the control zone can be provided with an immobilized binding reagent that will bind to a labeled binding reagent present in the device irrespective of whether analyte is present. The control may be provided downstream from the detection zone. Alternatively, the control zone can contain an anhydrous reagent that, when moistened, produces a color change or color formation, e.g. anhydrous copper sulphate which will turn blue when moistened by an aqueous sample. As a further alternative, a control zone could contain immobilized analyte which will react with excess labeled reagent from the first zone.

The porous carrier components may be provided within a housing. The housing will preferably be fluid impermeable. A suitable material for the housing is plastic, such as ABS.

Also provided as part of the device are two or more sample activatable battery cells provided in series connection. The sample activatable battery cells are preferably located upstream of the labeled binding reagent. The plurality of sample activatable battery cells may provided on and/or within the porous sample receiver. Alternatively, the sample activatable battery cells may be provided on and/or within the first porous carrier. As yet a further alternative, the sample activatable battery cells may be provided on both the porous sample receiver and the first porous carrier.

The battery electrodes may be provided directly on the surface of the porous sample receiver or first porous carrier. Alternatively, the electrodes may be provided within the body of the porous sample receiver or first porous carrier. Yet alternatively the electrodes may be provided as wires, spikes or the like which are capable of being inserted or attached to the porous sample receiver or the first porous carrier.

Alternatively, the battery cells may be provided on a separate substrate which may be attached or laminated to the device. The substrate may be porous or fluid permeable to allow fluid sample to enter the porous sample receiver. Suitable substrates are plastic such as Mylar™ or paper or other cellulosic material.

The battery electrodes may be suitably prepared by printing a conductive particle containing ink, such as containing metal or carbon particles by methods such as screen printing or lithographic printing. The inks preferably comprise a high loading of conductive particles, such as 80% by weight, in a suitable printing “vehicle” which may comprise an organic solvent, viscosity modifiers, a polymer binder and the like.

The electrode pairs may be of any convenient size or shape. Ideally, the anode and cathode are of a similar size and shape to provide the optimum battery characteristics. Where a plurality of sample activatable battery cells are provided, they may be arranged in a suitably compact form such as in an interdigitated, concentric or stacked arrangement.

Depending upon the sensitivity or stability of the binding reagents to reactants produced by the electrochemical reaction or to components of the battery cells, a barrier or impediment to flow may be provided in the vicinity of the battery cells. The barrier may be chosen from, for example, a non-porous substrate such as a thin layer of plastic such as polyester, polyethylene, a porous substrate such as a porous polymeric sheet, a semi-permeable membrane, a water swellable polymer or gel or a fluid permeable substrate such as cellulose. The barrier may extend substantially around the battery cells forming a compartment. Thus, species such as metal ions or protons either produced as a consequence of the electrode reaction or provided as electrolytes may be prevented or impeded from flowing downstream of the battery cells and interacting with the binding reagents. The barrier may comprise the battery electrolyte.

A buffer and/or an agent to sequester metal ions may be provided downstream from the battery cells and upstream from the binding reagents in order to remove or reduce the amount of protons or metal ions in solution or provide an optimal pH for the binding reagents. Depending upon the electrode reaction an acid or alkaline electrode may be employed. Examples of metal sequestering agents include EDTA and NTA. The sequestering agents may themselves immobilized to the porous substrate.

It is important that the resistance of the electrodes be as low as possible in order to provide the appropriate voltage and current. This may be achieved by providing the electrodes as thin layers. The layer may be between about 1 and about 50 μm, preferably between about 5 and about 30 μm. Low resistance conductors such as gold, silver or carbon may be provided in electrical connection with the battery electrodes in order to further decrease the internal resistance. Silver is the preferred material of choice. The connectors may also be provided as a thin layer, typically between about 1 and about 10

The number and arrangement of sample activatable battery cells provided can be tailored to accommodate the power requirements of the electronic components of the assay device. Battery cells may additionally be provided in parallel depending upon the current requirements.

The battery cells may be connected to the power requiring components of the device by leads or conductive tracks which may be present on the internal surface of a housing encasing the porous sample transporting components.

One or more of the sample activatable battery cells may also function as a fluid sample presence indicator indicating to the device that fluid sample has been added.

According to a preferred embodiment, the presence or amount of labeled binding reagent is detected optically. In this case, the assay device additionally comprises one or more light sources such as an LED and one or more corresponding light detectors as well as corresponding signal transduction means, computing means, display means as well as associated electronic circuitry, which together make up the power requiring or consuming parts of the device. The one or more light sources and one or more corresponding light detectors are positioned with respect to the detection zone such that light from the light source interacts with the labeled material and either the transmitted or reflected radiation is detected by the light detector.

The porous sample receiving member can be made from any bibulous, porous or fibrous material capable of absorbing liquid rapidly. The porosity of the material can be unidirectional (i.e. with pores or fibres running wholly or predominantly parallel to an axis of the member) or multidirectional (omnidirectional, so that the member has an amorphous sponge-like structure). Porous plastics material, such as polypropylene, polyethylene (preferably of very high molecular weight), polyvinylidene fluoride, ethylene vinylacetate, acrylonitrile and polytetrafluoro-ethylene can be used. It can be advantageous to pre-treat the member with a surface-active agent during manufacture, as this can reduce any inherent hydrophobicity in the member and therefore enhance its ability to take up and deliver a moist sample rapidly and efficiently. Porous sample receiving members can also be made from paper or other cellulosic materials, such as nitrocellulose. Materials that are now used in the nibs of so-called fiber tipped pens are particularly suitable and such materials can be shaped or extruded in a variety of lengths and cross-sections appropriate in the context of the invention. Preferably, the material comprising the porous receiving member should be chosen such that the porous member can be saturated with aqueous liquid within a matter of seconds. Preferably, the material remains robust when moist, and for this reason paper and similar materials are less preferred in any embodiment wherein the porous receiving member protrudes from a housing. The liquid must thereafter permeate freely from the porous sample receiving member into the first porous carrier.

The porous sample receiver may comprise one or more sections laminated to provide flow paths in differing directions. According to an embodiment, the battery cells are housed in a section of porous sample receiver whose direction flow is out of phase with the direction of flow of the remaining portion. Thus, fluid sample added to the porous sample is able to contact the battery cells as well as flow through the device. In this way, unwanted components or by-products of the battery reaction are impeded or prevented from flowing downstream through the device.

Alternatively, the battery components may be located in a region of the porous sample receiver which does not form part of the main flow path of the device.

As yet a further alternative, the two or more sample activatable battery cells may be provided downstream from the porous sample receiver and housed in a separate porous carrier to that of the binding reagents such that fluid sample added to the device is able to flow into the separate porous carrier as well as being able to flow through the first and second porous carriers of the assay device. In this way, interaction of the binding reagents with the battery cell components or reactants is removed or minimized.

The fluid sample can be derived from any source, such as a physiological fluid, including blood, serum, plasma, saliva, urine, mucous, semen, vaginal or urethral secretions and interstitial fluid. Fluid samples may alternatively be derived from biological, industrial or environmental sources.

Analytes include, but are not limited to, toxins, organic compounds, proteins, peptides, microorganisms, bacteria, viruses, amino acids, nucleic acids, carbohydrates, hormones, steroids, vitamins, drugs, pollutants, pesticides, and metabolites of or antibodies to any of the above substances. The term analyte also includes any antigenic substances, haptens, antibodies, macromolecules, and combinations thereof.

A variety of battery types may be used in the assay devices. Fuel cells such as metal/air batteries may be employed including zinc/carbon, aluminium/carbon, silver/carbon, copper/carbon and magnesium/carbon as well as other batteries such as magnesium/copper, zinc/manganese dioxide, zinc/copper, zinc/silver, and zinc/copper. It is preferable to use an air battery such as, due to the high oxygen content in urine.

Examples of the half-cell reactions are given below:

Zinc - Air (1.65 V)

| | |
|---|---|
| Zn + 4OH— → Zn(OH)2 + 2e− | Zinc (Anode) −ve |
| O2 + 2H2O + 2e+ → 4OH— | Carbon (Cathode) +ve |

Voltaic (1.2 V)

| | |
|---|---|
| Zn → Zn2+ + 2e− | Zinc (Anode) −ve |
| Cu2+ + 2e− → Cu | Copper (Cathode) +ve |

The voltages shown above are the theoretical voltages that may be obtained from employing the particular electrode pair, however the actual or working voltage will be less due to kinetically limiting processes and internal battery resistance.

An electrolyte may be provided between the electrode pair depending upon the electrode pair. For example, an alkaline electrolyte is suitable for metal/air batteries and an acid electrolyte is preferable for example for a Zn/Cu battery. The electrolyte may additionally comprise metal ions, such as in the case of a Zn/Cu battery, copper ions. The electrolyte may be provided as a gel such as a PVA gel in order to prohibit diffusion of the electrolyte components from the electrodes.

Depending upon the fluid sample in question, salts may be provided within the device to increase its ionic strength in order to improve the battery efficiency. For example, urine may have a much higher ionic strength than saliva. The salts may be provided in the immediate vicinity of the battery electrodes and may be provided in a slow dissolving form such as within a polymeric gel to reduce the likelihood of the components travelling further downstream.

The total charge obtainable from a battery cell will in part be determined by the electrode mass and the effective electrode area.

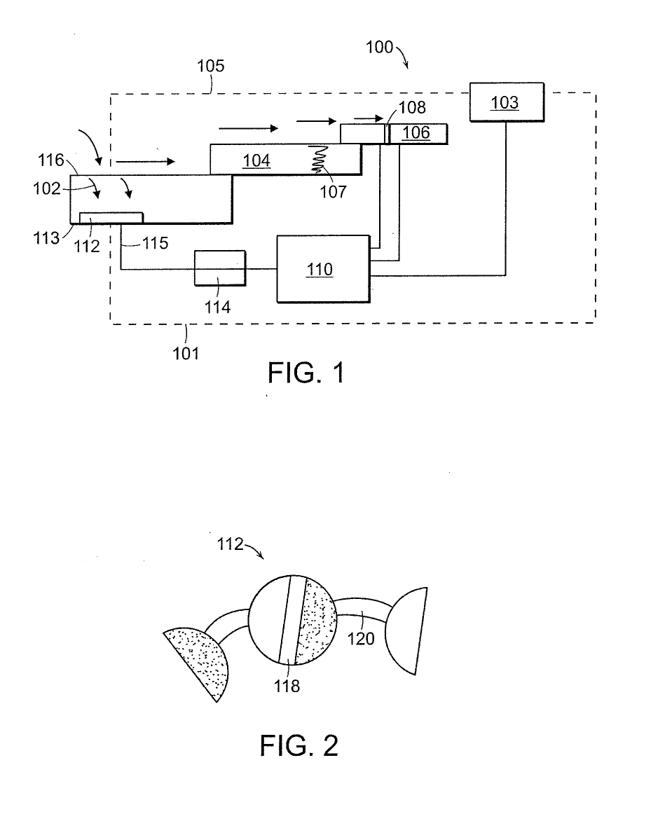

Referring to FIG. 1, an assay device designated generally 100 can seen schematically in more detail. The device comprises a casing 101 which has an LCD or other electronic display 103 located on a portion of its upper surface 105, preferably situated towards one end of the casing 101. Protruding from the casing, preferably at the end opposite to where the electronic display 103 is situated, is a porous sample receiver 102 which, as described in more detail below, is provided to receive the substance sample and to draw it towards components inside the device casing 101. The porous sample receiver 102 is substantially rectangular in cross section, having an upper surface 116 and a lower surface 113, having a length of approximately 3 cm, a width of approximately 1 cm and a thickness of approximately 3 mm and is capable of absorbing a volume of fluid of approximately 900 μL. The porous sample receiver 102 extends inside the casing 101, with approximately two thirds of the porous sample receiver 102 being visible from the outside.

The porous sample receiver 102 is partially overlaid and in fluid connection with a first porous carrier which in turn is overlaid and in fluid connection with a second porous carrier. Inside the casing 101 the porous sample receiver 102 adjoins to one end of a first porous carrier 104. The first porous carrier 104 is rectangular in cross section, having a length of approximately 2 cm, a width of approximately 1 cm and a thickness of approximately 100 μm and is capable of absorbing a volume of approximately 150 μL. The first porous carrier comprises a dried labeled binding reagent. At its distal end, the first porous carrier 104 connects to a second porous carrier 106. The second porous carrier 106 is a thin, rectangular strip of nitrocellulose microporous material of 5-8 μm having a length of approximately 4 cm, a width of 0.8 cm and a thickness of approximately 50 μm and, capable of absorbing a volume of fluid of approximately 40 μL. The second porous carrier 106 includes a detection zone 108 comprising an immobilised binding reagent for either the analyte or the labeled binding reagent depending upon whether the test to be carried out is a sandwich or competition assay. Together, the first porous carrier, the first porous carrier and the porous sample receiver make up the test strip (106).

In use, fluid sample to be tested is applied to the porous sample receiver 102, and flows to the first porous carrier 104 whereupon it resuspends and mobilizes the labeled binding reagent. The sample, including labeled binding reagent, will then continue to flow into and along the first porous carrier 106. When the sample reaches the detection zone 108 on the first porous carrier 106, labeled antibody or labeled antibody analyte complex antibody label is bound by the immobilized binding reagent at the detection zone to provide an indication of the presence and/or amount of analyte in the fluid sample.

The test strip 106 is precisely located within the device relative to the optical light source and detection means such that light from the light source is able to interact with the detection zone of the second porous carrier and be detected by the light detector. The device may comprise one or more light sources and one or more light detectors.

In one embodiment, the device comprises three light sources: a first light source arranged to measure the background level of the second porous carrier, a second light source arranged to measure the labeled material present at the detection zone and a third light source arranged to measure labeled material present at a control zone.

The display means may either display a numerical result of the analyte concentration, or depending upon the nature of the test, the words “POSITIVE” or “NEGATIVE”, “HIGH” “LOW” or “MEDIUM”, “PREGNANT” or “NOT PREGNANT” and so on. Alternatively the display may display a symbol.

In order to provide power to the device, a plurality of sample activatable battery cells 112 are provided on the lower surface 113 of the porous sample receiver 102.

The current generated in the sample activatable battery cells 112 on the lower surface 113 of the porous sample receiver 102 is provided to the power requiring components of the device by conductive tracks. According to one embodiment, back connectors 115 are provided inside the device casing 101, and preferably on the inner surface of the casing 101, connecting the sample activatable battery cells 112 to the electronic components. Optionally, a controller 114 is also provided in the circuit providing power and control commands to the assay channel 110 and display 103. To ensure that the fluid sample does not contact the conductive tracks they may covered by insulating material.

Referring now to FIG. 2, an embodiment of an individual sample activatable battery cell 112 can be seen in more detail. In particular the individual battery cells 112 comprise an electrode anode-cathode pair 112a, 112b with a sample channel 118 therebetween. Consecutive battery cells 112 are connected via connections 120.

The plurality of sample activatable battery cells 112 are successively connected in series and optionally in parallel depending on the power requirements of the electronic components which are they being used to power. That is, when activated by a sample or any other electrolyte, each battery cell 112 produces a voltage. When a number of battery cells 112 are connected in series, a larger sum voltage can be achieved. Conversely, if a plurality of battery cells 112 are additionally connected in parallel, a larger sum current can be achieved. It is therefore possible to tailor the voltage and the current achievable from the plurality of sample activatable battery cells 112 by selecting, during design, the number of cells 112 used and their specific connectivity configuration. It is also possible, for example, to increase the current produced by the cells 112 by increasing their size or surface area. Yet further, tolerance and redundancy can be built into the arrangement such that short circuiting of some cells 112 will not reduce the voltage produced by the battery as a whole below a predetermined threshold.

As well as having to provide the requisite power supply to the electronic components in the device 100, the sample activatable battery cells 112 need to be provided in a configuration which is accommodated on the limited surface area of the porous sample receiver 102. In order to provide the necessary connectivity configuration in a compact and simple manner on the surface 113 of the porous sample receiver 102, the plurality of battery cells 112 can be provided in a generally circular configuration and in a staggered concentric arrangement.

The electrodes may be printed onto to the surface of the porous sample receiver 102. It will be appreciated that screen printing allows the electrodes to be provided in a straightforward, cost-effective and easily reproducible manner. Screen printing further assures that the electrodes are securely affixed to the porous sample receiver 102, and will not become detached or lose their configuration during storage, transport or use of the assay device.

Although in the assay device 100 according to the present embodiments, the sample being tested acts as an electrolyte for the battery cells 112, depending on the sample, it may be desired to enhance its electrolytic properties using a sample soluble conductive material such as a salt. When the salt comes into contact with the sample it will dissolve and provide the desired electrical properties. One salt suitable for this purpose is copper sulphate acidified with potassium hydrogen sulphate in a suitable polyvinyl alcohol (PVA) or other polymer solution, such as Sigma-Aldrich 85 k to 146 k molecular weight PVA. Increasing the PVA concentration in the salt/PVA solution increases its viscosity, which is useful for screen printing. In addition, dissolving the salts in PVA allows slow release of the salts so that they are not washed away by the sample on wetting, and allows an even and homogenous layer of salts to be deposited. An increased salt content surrounding the battery cells increases their hydrophilic nature, which is further increased by the PVA also retaining moisture. Other agents such as sugars may also be provided to control release of the salts.

In this case, in their simplest form each cell comprises a zinc (in carbon paste) anode and a carbon cathode in an acidified salt solution such as copper sulphate acidified with potassium hydrogen sulphate. When the sample activates the cell the zinc is oxidised at the anode and the copper ions (from the salt) are reduced to copper metal at the cathode. In an opposing reaction at the cathode, H+ ions are converted to hydrogen gas. The theoretical voltage of each cell is 1.2V.

In a similar manner to that, as previously described, according to this embodiment in use the user deposits the sample to be tested onto the porous sample receiver 102. A proportion of the sample deposited will be directed along the porous sample receiver 102 to the first porous carrier 104 and second porous carrier 106 in order to be analysed, and a proportion of the sample will diffuse into the porous sample receiver 102, towards its lower surface 113. When the sample reaches the lower surface 113 it will come in contact with the sample activatable battery cells 112. At this point an electrochemical reaction occurs in the cell 112 and a voltage is provided and output to the appropriate electrical components within the device 100.

As a result of the electrochemical reaction occurring at the battery cells 112, by-products may be produced such as protons and metal ions which may effect the binding characteristics of the assay

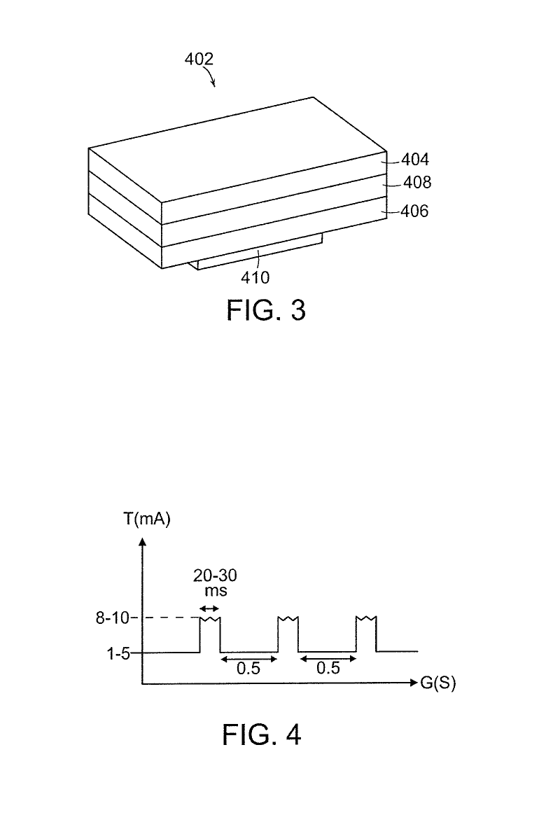

In FIG. 3, a solution to by-product sample contamination can be seen. According to this embodiment a porous sample receiver 402 is provided comprising an upper layer 404 and a lower layer 406. A plurality of sample activatable battery cells 410 are provided on the lower-most surface of the lower layer 406. The upper 404 and lower 406 layers are separated by a barrier 408. The barrier 408 is a non-diffusible or semi-diffusible membrane such that any sample deposited on the porous sample receiver 402 may diffuse downwards through the barrier 408 and into contact with the sample activatable battery cells 410 on the lower surface of the porous sample receiver 402, however neither the sample nor any by-product can diffuse upwards from the lower layer 406 to the upper layer 404. This allows any uncontaminated sample in the upper layer 404 to continue to the rest of the strip to be tested and analysed accordingly. In an alternative embodiment, the barrier 408 may comprise a polymer gel in which the electrolyte may be provided which will prevent diffusion of by-products through the barrier 408 to the upper layer 404. The barrier 408 may further comprise means to sequester or remove undesirable by-products of the electrode reaction.

The sample activatable battery cells 112 are therefore designed to provide the required power to the electronic components in the device reliably and continuously over that test period. For example, the current requirements of a typical LED component in the assay device 100 is shown in FIG. 4. As may be seen from FIG. 4, at every 0.5 second interval, the LED activates for 20 to 30 milliseconds, increasing the LED's current requirement from 1.5 milliamps to 8-10 milliamps. In addition a voltage of at least 3V is required.

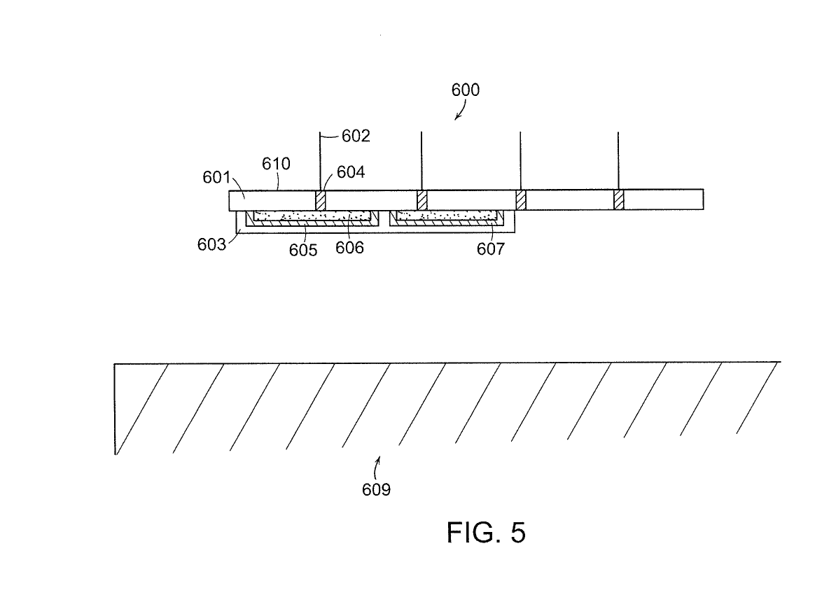

FIG. 5 shows an exemplary construction of a sample activatable battery cell.

Substrate 601 is provided with though holes which may be filled with a conductive material 604 which is attached to conductive track or lead 602. Provided on one surface of the substrate and in electrical contact with paste 604 is optionally a first layer of low resistance conductor 606. A similar arrangement is provided for the adjacent electrode comprising the cathode layer 607. Provided over layer 606 is a further layer of the anode material. A gel containing electrolyte 603 may optionally be provided in the vicinity of each anode and cathode. The battery cells 600 may then be attached to the assay device, for example to the porous sample receiver 609 or provided as part of the assay device, for example within the housing and separate from the porous components of the device. The conductive lead or tracks 602 lead to the power requiring components of the device and may be conveniently provided on the inner surface of the housing or may lead to further connectors and leads provided on the inner surface of the housing. It is important to ensure than the conductor 606, material 604 and leads 602 do not come into contact with the fluid sample and are appropriately isolated from it. One way of doing this is to provide an insulating layer over the surface 610 of the substrate. It is also important that the electrode layer completely cover the underlying conductor. In the case where an underlying conductor is present it is important to ensure that the electrode layer is of a sufficient thickness such that fluid sample is not able to contact the conductor 606 for the duration of the test. The leads 602 of the respective battery cells may be connected to provide series and optional parallel connections as appropriate.

As a result of the embodiments described, a self powered assay device capable of producing an appropriate voltage is provided. The device can be fabricated in a simple manner with a minimal number of components. In addition, during fabrication the connectivity configuration of the battery can be tailored according to the requirements of the electrical components comprised within the device. Advantageously, no additional surface or compartment is required to house the battery and no user input other than depositing of the sample is required in order to activate the battery and run the test.

The porous sample receiver may comprise a single component comprising sample activatable battery cells, however it is possible to provide a porous sample receiver having a separate flow channel in which the sample activatable battery cells are provided. The separate flow channel may be isolated from the remainder of the porous sample receiver such that no or little fluid can flow into the main body of the porous sample receiver.

### EXEMPLIFICATION

The invention, having been generally described, may be more readily understood by reference to the following examples, which are included merely for purposes of illustration of certain aspects and embodiments of the present invention, and are not intended to limit the invention in any way. All headings are for the convenience of the reader and should not be used to limit the meaning of the text that follows the heading, unless so specified.

### Example 1

Silver ink (available from Gwent Electronic Materials) was screen printed on a polymer substrate and allowed to dry, providing a layer of dimensions, 2.3 cm long by 2.0 cm wide by 5 μm depth. A zinc particle ink (80% Zn w/w) was screen printed on top of the silver layer having dimensions of 2.3 cm long, a width of 0.2 cm and a thickness of 20 μm. The overall resistance of the resulting Zn/Cu, Zn/C and Zn/AgCl battery cells were prepared by screen printing cathodes over a silver layer and having the same dimensions as that of the anode. Urine was added to the porous sample receiver and the voltages monitored over time.

The results are shown in the Table below:

| Electrodes | 0 mins | 5 mins | 10 mins | 15 mins |
|---|---|---|---|---|
| Zn/Cu | 0.72 | 0.71 | 0.68 | 0.65 |
| Zn/C | 0.82 | 0.79 | 0.79 | 0.78 |
| Zn/AgCl | 0.91 | 0.89 | 0.89 | 0.87 |

### EQUIVALENTS

Those skilled in the art will recognize, or be able to ascertain using no more than routine experimentation, many equivalents to the specific embodiments of the invention described herein. While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations. Such equivalents are intended to be encompassed by the following claims.

### REFERENCES

All publications and patents mentioned herein, including those items listed below, are hereby incorporated by reference in their entirety as if each individual publication or patent was specifically and individually indicated to be incorporated by reference. In case of conflict, the present application, including any definitions herein, will control.

WO00/33063

U.S. Pat. No. 5,869,972

1. An assay device, comprising:
(a) a sample transporting means; and
(b) two or more sample activatable battery cells connected in series on the sample transporting means.

2. The assay device of claim 1, comprising three or more sample activatable battery cells connected in series on the sample transporting means.

3. The assay device of claim 1, wherein the sample transporting means comprises at least one porous carrier.

4. The assay device of claim 3, wherein the sample transporting means comprises a first porous carrier in contact with a downstream second porous carrier.

5. The assay device of claim 4, further comprising a porous sample receiving member upstream from and in contact with the first porous carrier.

6. The assay device of claim 4, wherein the first porous carrier comprises a mobilizable labeled binding reagent and the second porous carrier comprises an immobilized binding reagent.

7. The assay device of claim 5, wherein the two or more sample activatable battery cells are located on or in the porous sample receiving member.

8. The assay device of claim 4, wherein the two or more sample activatable battery cells are located on or in the first porous carrier.

9. The assay device of claim 8, wherein the porous carrier comprises a barrier to sample flow near the two or more sample activatable battery cells.

10. The assay device of claim 9, wherein the barrier is on the surface of the porous sample receiving member.

11. The assay device of claim 9, wherein the barrier is within the porous sample receiver.

12. The assay device of claim 9, wherein the barrier substantially encloses the sample activatable battery cells.

13. The assay device of claim 9, wherein the barrier comprises one or more of a buffer, a metal ion sequestering agent and a salt.

14. The assay device of claim 1, wherein a low resistance conductive layer is disposed underneath at least one electrode of the sample activatable battery cells.

15. The assay device of claim 14, wherein the low resistance conductive layer is silver.

16. The assay device of claim 15, wherein the thickness of the silver is between about 10 and about 30 μm.

17. The assay device of claim 2, wherein the sample activatable battery cells are connected in parallel.

18. The assay device of claim 1, wherein the sample activatable battery cells provide a working voltage of at least about 3V and a working current of at least about 10 mA when activated.

19. The assay device of claim 1, wherein one or more of the battery activatable cells also functions as a fluid sample presence indicator.

20. An assay device, comprising:
(a) a porous receiving member;
(b) a first porous carrier in contact with the porous receiving member, wherein the first porous carrier comprises a mobilizable dried labeled binding reagent and an immobilized unlabeled binding reagent, the labeled and unlabeled specific binding reagents being capable of binding the analyte; and
(c) two or more sample activatable battery cells provided in series.

21. The assay device of claim 20, wherein the immobilized unlabeled binding reagent is immobilized in a detection zone on the first porous carrier.

22. The assay device of claim 21, further comprising:
(d) a light source; and
(e) a photodetector.

23. The assay device of claim 21, further comprising a control zone having an immobilized binding reagent specific for the labeled binding reagent provided downstream from the detection zone.

24. The assay device of claim 20, comprising three or more battery activatable cells provided in series.

25. The assay device of claim 20 of 24, wherein the battery activatable cells are provided on the sample receiving member.

26. The assay device of claim 24, wherein the battery activatable cells are provided on the sample receiving member.
